(19) United States
(12) Patent Application Publication
(10) Pub. No.: US 2019/0094525 A1
(43) Pub. Date: Mar. 28, 2019

(54) ROTARY DRIVE APPARATUS

(71) Applicant: Nidec Corporation, Kyoto (JP)

(72) Inventor: Yoichi SEKII, Kyoto (JP)

(21) Appl. No.: 16/102,822

(22) Filed: Aug. 14, 2018

(30) Foreign Application Priority Data
Sep. 28, 2017 (JP) 2017-188561

(51) Int. Cl. G02B 26/08; H02K 7/02

(52) U.S. Cl. CPC G02B 26/0816; H02K 7/02

(57) ABSTRACT

A rotary drive apparatus rotates a flywheel that holds a mirror and a lens. An accommodating portion of the flywheel, in which the lens is arranged, includes a slanting surface radially inside of the lens and below a light path of reflected light, and slants radially outward with decreasing height, an outer wall portion opposite to the slanting surface, and a window portion structured to pass through the outer wall portion and to allow the base portion of the lens to be inserted therein. A shortest distance, measured along a normal to the slanting surface, between the slanting surface and a portion of an inner surface of the outer wall portion above the window portion is greater than a thickness of the base portion measured in a radial direction. A dimension of the window portion measured in a vertical direction is greater than a dimension of a portion of the base portion inserted in the window portion measured in the vertical direction. The dimension of the window portion measured in the vertical direction is smaller than a dimension of a projecting portion of the lens measured in the vertical direction.

### CROSS REFERENCE TO RELATED APPLICATIONS

This application claims the benefit of priority to Japanese Patent Application No. 2017-188561 filed on Sep. 28, 2017. The entire contents of this application are hereby incorporated herein by reference.

### BACKGROUND OF THE INVENTION

### 1. Field of the Invention

The present invention relates to a rotary drive apparatus.

### 2. Description of the Related Art

A known scanner apparatus used for position recognition in a head-mounted display (HMD) or the like typically has installed therein optical components, such as, for example, a mirror arranged to reflect incoming light coming from a light source, and a lens arranged to allow reflected light to pass therethrough. A known apparatus including an optical component, such as, for example, a lens, is described in, for example, JP-A 2009-283021.

However, a known optical apparatus described in JP-A 2009-283021 does not include a guide portion or the like arranged to guide a lens to a predetermined position on a base (i.e., a holder) arranged to hold the lens when the lens is disposed at the predetermined position on the base. It is therefore necessary to hold the lens with a human hand, a jig, or the like, and directly carry the lens to the predetermined position on the base, which leads to a reduction in workability in assembling the apparatus.

### SUMMARY OF THE INVENTION

Preferred embodiments of the present invention provide rotary drive apparatuses that achieve improved assembling workability.

A rotary drive apparatus according to a preferred embodiment of the present invention rotates a flywheel that holds a mirror that reflects incoming light coming from a light source, and a lens that allows reflected light obtained by reflection of the incoming light to pass therethrough. The rotary drive apparatus includes a motor and the flywheel, the flywheel being supported by the motor to rotate about a central axis extending in a vertical direction. The lens includes a base portion including a light-transmitting portion that allows the reflected light to pass therethrough; and a projecting portion projecting in an axial direction relative to the base portion. The flywheel includes an accommodating portion in which the lens is located. The accommodating portion includes an insertion opening at an upper portion of the accommodating portion to have the lens inserted therethrough; a support surface located below a light path of the reflected light to support the lens; a slanting surface located radially inside of the lens and opposite to a radially inner surface of the lens, at a position at least below the light path of the reflected light, and slanting radially outward with decreasing height; an outer wall portion located radially outside and opposite to the slanting surface, and extending in the axial direction; and a window portion extending through the outer wall portion in a radial direction and including a portion of the base portion of the lens inserted therein. The insertion opening extends from the slanting surface to an inner surface of the outer wall portion in the radial direction. The shortest distance, measured along a normal to the slanting surface, between the slanting surface and a portion of the inner surface of the outer wall portion which lies above the window portion is greater than a thickness of the base portion of the lens measured in the radial direction. A dimension of the window portion measured in the vertical direction is greater than a dimension of a portion of the base portion which has been inserted in the window portion measured in the vertical direction. The dimension of the window portion measured in the vertical direction is smaller than a dimension of the projecting portion of the lens measured in the vertical direction.

The rotary drive apparatus according to the above preferred embodiment of the present invention allows the lens to be inserted along the slanting surface when the lens is in the accommodating portion. This leads to improved workability in assembling the rotary drive apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a light source, a frame, and a rotary drive apparatus according to a preferred embodiment of the present invention.

FIG. 2 is a vertical sectional view of a rotary drive apparatus according to a preferred embodiment of the present invention.

FIG. 3 is a perspective view of a flywheel according to a preferred embodiment of the present invention.

FIG. 4 is a perspective view of a lens according to a preferred embodiment of the present invention as viewed from outside the rotary drive apparatus.

FIG. 5 is a perspective view of a lens according to a preferred embodiment of the present invention as viewed from inside the rotary drive apparatus.

FIG. 6 is a vertical sectional view illustrating an accommodating portion arranged to accommodate a lens according to a preferred embodiment of the present invention.

FIG. 7 is a vertical sectional view illustrating an accommodating portion that accommodates a lens according to a preferred embodiment of the present invention.

FIG. 8 is a vertical sectional view illustrating an accommodating portion, which is able to accommodate a lens, of a rotary drive apparatus according to a first modification of a preferred embodiment of the present invention.

FIG. 9 is a vertical sectional view illustrating an accommodating portion, which is able to accommodate a lens, of a rotary drive apparatus according to a second modification of a preferred embodiment of the present invention.

FIG. 10 is a vertical sectional view illustrating an accommodating portion, which is able to accommodate a lens, of a rotary drive apparatus according to a third modification of a preferred embodiment of the present invention.

FIG. 11 is a vertical sectional view illustrating an accommodating portion, which is able to accommodate a lens, of a rotary drive apparatus according to a fourth modification of a preferred embodiment of the present invention.

### DETAILED DESCRIPTION OF THE PREFERRED EMBODIMENTS

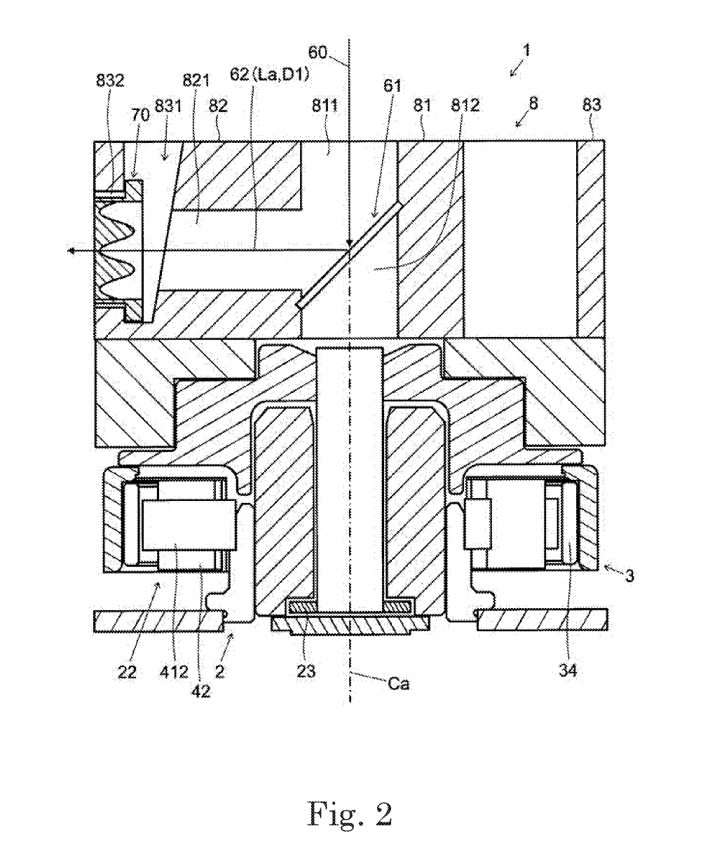

Hereinafter, preferred embodiments of the present invention will be described in detail with reference to the accompanying drawings. It is assumed herein that a direction in which a central axis of a motor of a rotary drive apparatus extends is referred to simply by the term “axial direction”, “axial”, or “axially”, that directions perpendicular to the central axis of the motor and centered on the central axis are each referred to simply by the term “radial direction”, “radial”, or “radially”, and that a direction along a circular arc centered on the central axis of the motor is referred to simply by the term “circumferential direction”, “circumferential”, or “circumferentially”. It is also assumed herein that an axial direction is a vertical direction for the sake of convenience in description, and the shape of each member or portion and relative positions of different members or portions will be described on the assumption that a vertical direction and upper and lower sides in FIG. 2 are a vertical direction and upper and lower sides of the rotary drive apparatus. It should be noted, however, that the above definition of the vertical direction and the upper and lower sides is not meant to restrict in any way the orientation of, or relative positions of different members or portions of, a rotary drive apparatus according to any preferred embodiment of the present invention when in use.

It is also assumed herein that, regarding a lens of a rotary drive apparatus, a direction in which an optical axis passing through the lens extends is referred to as an “optical axis direction”, and that directions perpendicular to the optical axis and centered on the optical axis are each referred to as a “lens radial direction”. The shape of each portion of the lens and relative positions of different portions of the lens will be described based on the above assumption. It is also assumed herein that a sectional view parallel to the axial direction is referred to as a “vertical sectional view”. Note that the wordings “parallel”, “at right angles”, “perpendicular”, etc., as used herein include not only “exactly parallel”, “exactly at right angles”, “exactly perpendicular”, etc., respectively, but also “substantially parallel”, “substantially at right angles”, “substantially perpendicular”, etc., respectively.

### 1. Structure of Rotary Drive Apparatus

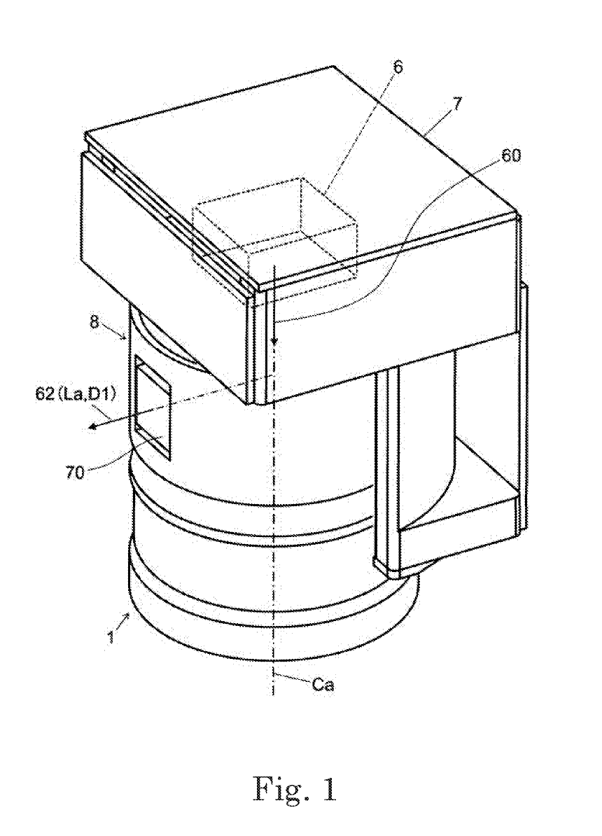

FIG. 1 is a perspective view of a light source 6, a frame 7, and a rotary drive apparatus 1 according to a preferred embodiment of the present invention. Referring to FIG. 1, the rotary drive apparatus 1 is an apparatus arranged to rotate a flywheel 8 that holds optical components each of which is arranged to reflect incoming light 60 coming from the light source 6 in a radial direction (i.e., a first radial direction D1) or allow the incoming light 6 to pass therethrough. The optical components include a lens 70 and a mirror 61 (see FIG. 2).

The frame 7 is arranged above the rotary drive apparatus 1. The frame 7 is fixed to a casing or the like in which the rotary drive apparatus 1 is arranged. The light source 6 is installed in the frame 7.

The light source 6 is arranged to emit the incoming light 60, which travels downward along a central axis Ca of a motor 10. In the present preferred embodiment, each of the light source 6 and the frame 7 is arranged outside of the rotary drive apparatus 1. Note, however, that each of the light source 6 and the frame 7 may alternatively be included in the rotary drive apparatus 1.

The rotary drive apparatus 1 includes the motor 10, the flywheel 8, and the optical components (i.e., the lens 70 and the mirror 61) held by the flywheel 8.

### 2. Structure of Motor

FIG. 2 is a vertical sectional view of the rotary drive apparatus 1 according to a preferred embodiment of the present invention. Referring to FIG. 2, the motor 10 includes a stationary portion 2 including a stator 22, and a rotating portion 3 including a magnet 34. The stationary portion 2 is arranged to be stationary relative to the casing or the like in which the rotary drive apparatus 1 is arranged. The rotating portion 3 is supported through a bearing portion 23 to be rotatable about the central axis Ca, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3. As a result, the rotating portion 3 is caused to rotate about the central axis Ca with respect to the stationary portion 2. Thus, the flywheel 8, which is rotatably supported by the rotating portion 3, is caused to rotate about the central axis Ca together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

### 3. Structure of Flywheel

Referring to FIG. 2, the flywheel 8 is supported by an upper end portion of the rotating portion 3 of the motor 10, and is arranged to rotate about the central axis Ca together with the rotating portion 3. The flywheel 8 is fixed to an upper surface of the rotating portion 3 through, for example, an adhesive or the like.

The flywheel 8 holds each of the mirror 61 and the lens 70. A resin, for example, is used as a material of the flywheel 8. Glass, for example, is used as materials of the mirror 61 and the lens 70. The glass is not limited to particular types of glass. For example, organic glass, inorganic glass, a resin, or a metal may be used as the materials of the mirror 61 and the lens 70, but other materials may alternatively be used.

The mirror 61 is in the shape of a plate, and is arranged to have a rectangular or circular external shape. The mirror 61 is fixed to a resin member of the flywheel 8, and at least a portion of the mirror 61 is arranged on the central axis Ca. A reflecting surface of the mirror 61 is inclined at an angle of 45 degrees with respect to the axial direction and the first radial direction D1. A fully reflective mirror, for example, is used as the mirror 61. The incoming light 60 impinges on a central portion of the mirror 61. The central portion of the mirror 61 refers to the entire mirror 61, excluding a peripheral portion of the mirror 61. The incoming light 60 is reflected by the mirror 61 inside of the flywheel 8, and is changed in the direction of travel. Note that, instead of the mirror 61, a prism (not shown) or the like may alternatively be used to change the direction of travel of the incoming light 60.

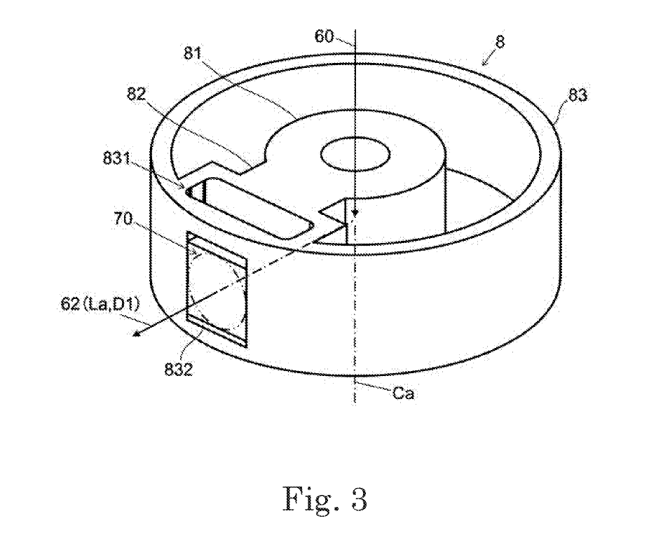

FIG. 3 is a perspective view of the flywheel 8 according to a preferred embodiment of the present invention. Referring to FIGS. 2 and 3, the flywheel 8 includes a vertical cylindrical portion 81, a horizontal cylindrical portion 82, and an outer cylindrical portion 83. In the present preferred embodiment, the vertical cylindrical portion 81, the horizontal cylindrical portion 82, and the outer cylindrical portion 83 are defined as a single monolithic member by a resin injection molding process. Note, however, that the vertical cylindrical portion 81, the horizontal cylindrical portion 82, and the outer cylindrical portion 83 may alternatively be defined by separate members.

The vertical cylindrical portion 81 is a cylindrical portion arranged to extend in the vertical direction along the axial direction in a radial center of the flywheel 8. The vertical cylindrical portion 81 has a cavity 811 defined radially inside thereof. The cavity 811 is arranged to extend in the vertical direction in parallel with the central axis Ca. The cavity 811 defines a light path.

The horizontal cylindrical portion 82 is a cylindrical portion arranged to extend radially outward in the radial direction (i.e., the first radial direction D1) from an outer circumferential portion of the vertical cylindrical portion 81. The horizontal cylindrical portion 82 has a cavity 821 defined inside thereof. The cavity 821 is arranged to extend in the radial direction perpendicularly to the central axis Ca. The cavity 821 is joined to the cavity 811 at right angles. The cavity 821 is arranged to overlap with each of the mirror 61 and the lens 70 when viewed in the first radial direction D1. The cavity 821 defines a light path.

The mirror 61 is fixed at a region at which the cavity 811 and the cavity 821 intersect with each other. In addition, the vertical cylindrical portion 81 has a cavity 812 below the region at which the mirror 61 is fixed. The cavity 812 is arranged to extend in the vertical direction in parallel with the central axis Ca. A portion of the incoming light 60 may alternatively be allowed to pass through the mirror 61 and then travel downward through the cavity 812.

The outer cylindrical portion 83 is a cylindrical portion arranged to extend in the vertical direction along the central axis Ca radially outside of the vertical cylindrical portion 81 and the horizontal cylindrical portion 82. An outer circumferential surface of the outer cylindrical portion 83 defines at least a portion of an outer circumferential surface of the flywheel 8. A radially outer end portion of the horizontal cylindrical portion 82 is joined to an inner circumferential surface of the outer cylindrical portion 83. Meanwhile, an outer circumferential surface of the vertical cylindrical portion 81 is joined to a radially inner end portion of the horizontal cylindrical portion 82. The outer cylindrical portion 83 has an accommodating portion 831 at a portion thereof to which the radially outer end portion of the horizontal cylindrical portion 82 is joined. The lens 70 is arranged in the accommodating portion 831. The structure of the accommodating portion 831 will be described in detail below.

The lens 70 is arranged to have an external shape being rectangular or circular when viewed in the optical axis direction passing through the lens 70. The lens 70 is accommodated in the accommodating portion 831, and is held by the flywheel 8, including the outer cylindrical portion 83. The lens 70 is arranged at right angles to the first radial direction D1 in the accommodating portion 831, and the lens 70 is arranged in parallel with the central axis Ca. An opening at a radially outer end portion of the cavity 821 of the horizontal cylindrical portion 82 is covered by the lens 70. The structure of the lens 70 will be described in detail below.

In the present preferred embodiment, the incoming light 60, which is emitted from the light source 6, enters the flywheel from above an upper surface of the flywheel 8, and travels downward along the central axis Ca in the cavity 811 of the vertical cylindrical portion 81. The incoming light 60 is reflected by the mirror 61 inside of the vertical cylindrical portion 81 to become reflected light 62. The reflected light 62 travels outward in the first radial direction D1 in the cavity 821 of the horizontal cylindrical portion 82, and is emitted out of the rotary drive apparatus 1 through the lens 70.

The mirror 61 of the flywheel 8 is arranged to reflect the incoming light 60 coming from the light source 6 and emit the reflected light 62 to an outside of the rotary drive apparatus 1 while rotating about the central axis Ca together with the rotating portion 3 of the motor 10. Thus, a wide range can be irradiated with light. The rotation speed of the rotary drive apparatus 1 can be recognized by sensing the reflected light 62, which is emitted out of the flywheel 8, using an external sensor (not shown). Note that the outer circumferential surface of the flywheel 8 has a light reflectivity lower than that of a front surface of the mirror 61. This contributes to preventing diffuse reflection of the incoming light 60 coming from the light source 6.

Note that the rotary drive apparatus 1 may further include, in addition to the flywheel 8 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is caused to be reflected in the first radial direction D1 to be emitted to the outside. A remaining half of the incoming light 60 which impinges on the mirror 61 is allowed to pass through the mirror 61 and further travel downward through the cavity 812 of the vertical cylindrical portion 81. A through hole (not shown) passing through the motor 10 in the axial direction is defined around the central axis Ca in the motor 10. The portion of the incoming light 60 which has passed through the mirror 61 passes through the through hole and reaches the other flywheel arranged below the motor 10. Then, the portion of the incoming light 60 which has reached the other flywheel is caused to be reflected in the second radial direction to be emitted to the outside, using a fully reflective mirror (not shown) in the other flywheel. Note that a plurality of mirrors (not shown), including a half mirror, which are arranged to reflect the incoming light 60 in mutually different directions may alternatively be installed in the single flywheel 8 of the rotary drive apparatus 1.

When light is emitted out in the two different directions, i.e., the first radial direction D1 and the second radial direction, as described above, light beams that are emitted out in the two different directions take different times to reach an object to be irradiated with light while the motor 10 is running, and this makes it possible to precisely recognize the three-dimensional position of the object in a space. Note that the other flywheel may alternatively be arranged in a rotary drive apparatus (not shown) other than the rotary drive apparatus 1 including the flywheel 8.

### 4. Structure of Lens

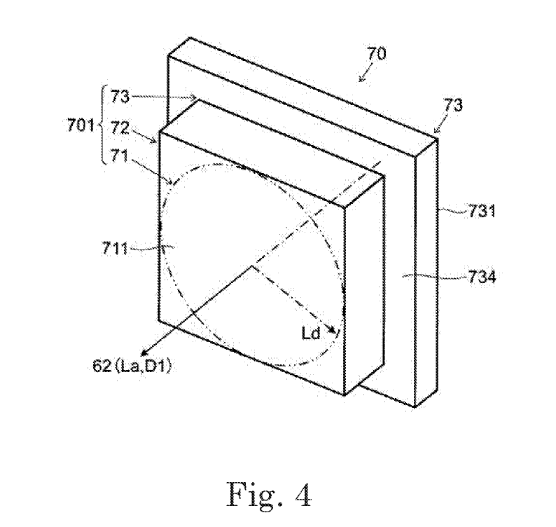

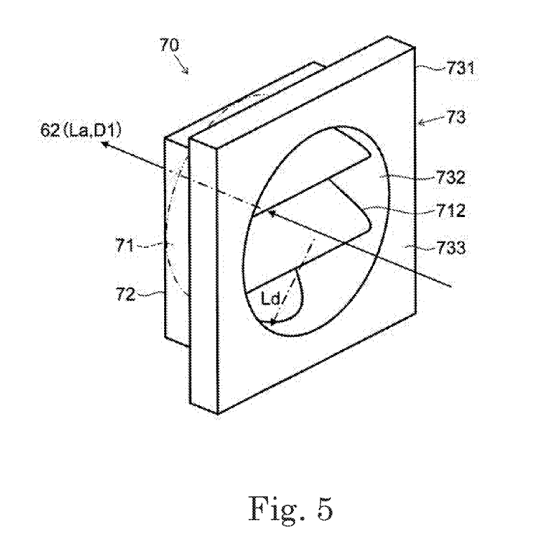

FIG. 4 is a perspective view of the lens 70 according to a preferred embodiment of the present invention as viewed from outside the rotary drive apparatus 1. FIG. 5 is a perspective view of the lens 70 according to a preferred embodiment of the present invention as viewed from inside the rotary drive apparatus 1. Referring to FIGS. 3 and 4, the lens 70 is arranged at right angles to an optical axis La passing through the lens 70. Note that the optical axis direction, in which the optical axis La passing through the lens 70 extends, coincides with the first radial direction D1. In the following description of the structure of the lens 70, the term “optical axis direction (D1)” is used as appropriate to describe the shapes of various portions of the lens 70 and relative positions of different portions of the lens 70.

The lens 70 includes a base portion 701 and a projecting portion 731. The base portion 701 includes a light-transmitting portion 71, a protective portion 72, and a collar portion 73. Note that the light-transmitting portion 71, the protective portion 72, and the collar portion 73 are defined by a single monolithic member.

The light-transmitting portion 71 is arranged to extend in lens radial directions Ld, which are perpendicular to the optical axis La, with the optical axis La as a center. The light-transmitting portion 71 is a portion arranged to allow the reflected light 62 to pass therethrough. The light-transmitting portion 71 is arranged to have an external shape being circular when viewed in the optical axis direction (D1), and is arranged to have a predetermined thickness in the optical axis direction (D1). The light-transmitting portion 71 includes an outer surface 711 on the side toward which the reflected light 62 is emitted (i.e., an outer side in the optical axis direction (D1)). The outer surface 711 is a flat surface extending in the lens radial directions Ld. The light-transmitting portion 71 has a curved and striped relief structure 712 on the side from which the reflected light 62 comes (i.e., an inner side in the optical axis direction (D1)).

The protective portion 72 is arranged outside of the light-transmitting portion 71 in the lens radial directions Ld. The protective portion 72 is a portion that does not allow the reflected light 62 to pass therethrough. The external shape of the protective portion 72 is in the shape of a rectangular parallelepiped, and the protective portion 72 is arranged to have a predetermined thickness in the optical axis direction (D1).

The collar portion 73 is arranged on the side of the protective portion 72 from which the reflected light 62 comes (i.e., the inner side in the optical axis direction (D1)). The collar portion 73 is a portion that does not allow the reflected light 62 to pass therethrough. The external shape of the collar portion 73 is in the shape of a rectangular parallelepiped, and the collar portion 73 is arranged to have a predetermined thickness in the optical axis direction (D1).

The collar portion 73 has a through hole 732. The through hole 732 is arranged to overlap or coincide with the light-transmitting portion 71 when viewed in the optical axis direction (D1) of the lens 70, and is arranged to pass through the collar portion 73 in the optical axis direction (D1) of the lens 70. A portion of the relief structure 712, which is a portion of the light-transmitting portion 71, is accommodated in the through hole 732. This prevents a portion of the light-transmitting portion 71 from protruding radially inward from an inner surface 733 of the collar portion 73. The inner surface 733 lies on the side of the collar portion 73 from which the reflected light 62 comes (i.e., the inner side in the optical axis direction (D1)). The light-transmitting portion 71 can thus be protected.

The projecting portion 731 is arranged to project in the axial direction relative to the base portion 701. Further, the projecting portion 731 is arranged to project in a lateral direction (i.e., a circumferential direction), which is perpendicular to each of the optical axis direction (D1) and the axial direction, relative to the base portion 701. That is, the projecting portion 731 does not overlap with the protective portion 72 when viewed in the optical axis direction (D1) of the lens 70, and projects outward in the lens radial directions Ld relative to an outer edge portion of the protective portion 72.

The projecting portion 731 includes a contact portion 734. The contact portion 734 is an outer surface that lies on the side of the projecting portion 731 toward which the reflected light 62 is emitted (i.e., the outer side in the optical axis direction (D1)). When the lens 70 is arranged in the accommodating portion 831, the contact portion 734 is brought into contact with an inner surface 8311, which will be described below, of the accommodating portion 831.

### 5. Structure of Accommodating Portion for Lens

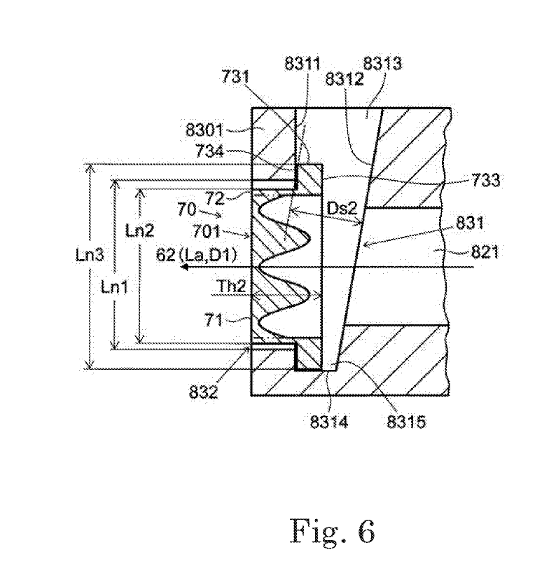

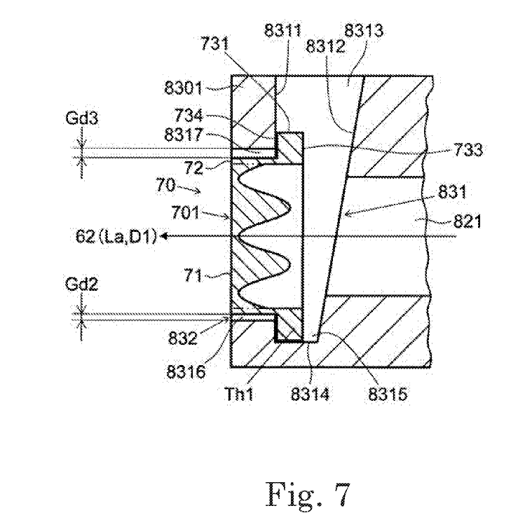

Each of FIGS. 6 and 7 is a vertical sectional view illustrating the accommodating portion 831, which is arranged to accommodate the lens 70 according to a preferred embodiment of the present invention. Referring to FIGS. 3, 6, and 7, the accommodating portion 831 is a cavity substantially in the shape of a rectangular parallelepiped, extending at right angles to the first radial direction D1, which is the direction of travel of the reflected light 62. That is, the accommodating portion 831 is arranged to extend in the axial direction (i.e., the vertical direction). The accommodating portion 831 is arranged to have an axial (i.e., vertical) dimension greater than that of the lens 70.

The accommodating portion 831 has an outer wall portion 8301, a slanting surface 8312, an insertion opening 8313, a support surface 8314, and a window portion 832.

The outer wall portion 8301 is arranged outside of the accommodating portion 831 in the first radial direction D1. The outer wall portion 8301 is arranged to extend in the axial direction. The outer wall portion 8301 defines a portion of an outer wall of the outer cylindrical portion 83. The inner surface 8311 of the outer wall portion 8301 is arranged opposite to the slanting surface 8312. The inner surface 8311 of the outer wall portion 8301 is arranged to extend in the lateral direction (i.e., the circumferential direction), which is perpendicular to each of the first radial direction D1 and the axial direction.

The slanting surface 8312 is arranged inside of the lens accommodated in the accommodating portion 831 in the first radial direction D1. The slanting surface 8312 is arranged opposite to the inner surface 733, which is a surface of the lens 70 which lies on the inner side in the first radial direction D1. The slanting surface 8312 includes at least portions arranged above and below the cavity 821 of the horizontal cylindrical portion 82, which defines a light path of the reflected light 62. The slanting surface 8312 is arranged to slant outward in the first radial direction D1 with decreasing height. That is, the slanting surface 8312 is arranged to slant with respect to the central axis Ca. As a result, a lower space of the accommodating portion 831 is smaller than an upper space of the accommodating portion 831, and is more adjacent to the inner surface 8311 of the outer wall portion 8301 than the upper space of the accommodating portion 831.

In the present preferred embodiment, the slanting surface 8312 is a flat surface extending above and below the cavity 821 of the horizontal cylindrical portion 82, which defines the light path of the reflected light 62. Note, however, that the slanting surface 8312 may alternatively be arranged to extend only below the cavity 821. The slanting surface 8312 can be easily defined when the slanting surface 8312 is the flat surface extending above and below the cavity 821.

In addition, the inclination angle of the slanting surface 8312 with respect to the central axis Ca is preferably arranged to be in the range of 5 degrees to 20 degrees. This arrangement optimizes workability in installing the lens 70 into the accommodating portion 831, the amount of an adhesive (not shown) used to fix the lens 70 in the accommodating portion 831, and the size of the flywheel 8.

The insertion opening 8313 is arranged at an upper portion of the accommodating portion 831. Thus, an upper end portion of the accommodating portion 831 is exposed axially upwardly of the flywheel 8. The insertion opening 8313 is arranged to extend from the slanting surface 8312 to the inner surface 8311 of the outer wall portion 8301 in the first radial direction D1. The lens 70 is inserted into the accommodating portion 831 through the insertion opening 8313.

The support surface 8314 is arranged at an inside bottom portion of the accommodating portion 831. The support surface 8314 is arranged below the light path of the reflected light 62 in the accommodating portion 831. The support surface 8314 is a flat surface arranged opposite to the insertion opening 8313 and extending radially. The support surface 8314 is arranged to support a lower surface of the projecting portion 731 of the lens 70 from below.

The window portion 832 is arranged at an edge portion of the accommodating portion 831 on the outer side in the first radial direction D1. The window portion 832 is arranged to pass through the outer wall portion 8301 in the first radial direction D1 to open into the outside of the flywheel 8. The window portion 832 is rectangular when viewed from the outer side in the first radial direction D1. The dimension of the window portion 832 measured in the lateral direction (i.e., the circumferential direction), which is perpendicular to each of the first radial direction D1 and the axial direction, is smaller than the dimension of the accommodating portion 831 measured in the lateral direction (i.e., the circumferential direction), which is perpendicular to each of the first radial direction D1 and the axial direction.

In the accommodating portion 831, the lens 70 is arranged at right angles to the first radial direction D1. At this time, the lens 70 is inserted into an interior of the accommodating portion 831 along the slanting surface 8312 through the insertion opening 8313. That is, in a process of inserting the lens 70 into the interior of the accommodating portion 831, the lens 70 is moved at an angle to each of the axial direction and the first radial direction D1. Once the lower surface of the projecting portion 731 of the lens 70 is brought into contact with the support surface 8314, the lens 70 is brought upright to be at right angles to the first radial direction D1 by moving an upper side of the lens 70 outward in the first radial direction D1. As a result, the contact portion 734 of the lens 70 is brought into contact with the inner surface 8311 of the outer wall portion 8301. Thus, the lens 70 is positioned with respect to the optical axis direction (D1) in the accommodating portion 831.

At this time, a portion of the lens 70, including the protective portion 72 of the base portion 701, is inserted into the window portion 832. The dimension of the protective portion 72 measured in the lateral direction (i.e., the circumferential direction), which is perpendicular to each of the optical axis direction (D1) and the axial direction, is substantially equal to the dimension of the window portion 832 measured in the lateral direction (i.e., the circumferential direction), which is perpendicular to each of the optical axis direction (D1) and the axial direction. The thickness of the protective portion 72 measured in the optical axis direction (D1) is substantially equal to the thickness of a portion of the outer wall portion 8301 around the window portion 832 measured in the optical axis direction (D1).

Here, referring to FIG. 6, the shortest distance Ds2, measured along a normal to the slanting surface 8312, between the slanting surface 8312 and a portion of the inner surface 8311 of the outer wall portion 8301 which lies above the window portion 832 is greater than the thickness Th2 of the base portion 701 of the lens 70 measured in the first radial direction D1. Further, the dimension Ln1 of the window portion 832 measured in the vertical direction is greater than the dimension Ln2 of a portion of the base portion 701 which has been inserted in the window portion 832 measured in the vertical direction. Still further, the dimension Ln1 of the window portion 832 measured in the vertical direction is smaller than the dimension Ln3 of the projecting portion 731 of the lens 70 measured in the vertical direction.

The configuration of the above-described preferred embodiment allows the lens 70 to be inserted along the slanting surface 8312 when the lens 70 is arranged in the accommodating portion 831. This leads to improved workability in assembling the rotary drive apparatus 1.

In addition, referring to FIGS. 6 and 7, the accommodating portion 831 has a first gap 8315, a second gap 8316, and a third gap 8317.

The first gap 8315 is defined at a bottom portion of the accommodating portion 831. The first gap 8315 is defined between the slanting surface 8312 and the inner surface 733, which is the surface of the lens 70 which lies on the inner side in the first radial direction D1. The first gap 8315 is a space extending in the first radial direction D1. This arrangement contributes to further improving assembling workability for the rotary drive apparatus 1 when the lens 70 is arranged in the accommodating portion 831.

The second gap 8316 is defined at a lower portion of the window portion 832. The second gap 8316 is a vertical gap defined between a wall surface of the window portion 832 and the portion of the base portion 701 which has been inserted in the window portion 832. The second gap 8316 is a space extending in the first radial direction D1 and in a direction crossing the first radial direction D1.

The third gap 8317 is defined at an upper portion of the window portion 832. The third gap 8317 is a vertical gap defined between the wall surface of the window portion 832 and the portion of the base portion 701 which has been inserted in the window portion 832. The third gap 8317 is a space extending in the first radial direction D1 and in a direction crossing the first radial direction D1.

In addition, the third gap 8317 (Gd3) is larger than the second gap 8316 (Gd2). This arrangement contributes to preventing the protective portion 72 of the base portion 701 from colliding against an outer edge of the window portion 832 when the lens 70 is arranged in the accommodating portion 831. This in turn contributes to further improving the assembling workability for the rotary drive apparatus 1 when the lens 70 is arranged in the accommodating portion 831.

### 6-1. Rotary Drive Apparatus According to First Modification

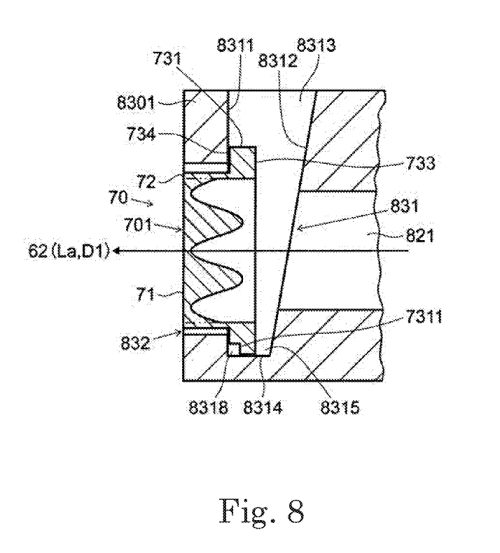

FIG. 8 is a vertical sectional view illustrating an accommodating portion 831, which is arranged to accommodate a lens 70, of a rotary drive apparatus 1 according to a first modification of the above-described preferred embodiment of the present invention. Referring to FIG. 8, a projecting portion 731 of the lens 70 has a recessed portion 7311. In addition, the accommodating portion 831 has a fourth gap 8318.

The recessed portion 7311 is defined at a corner portion of the projecting portion 731, the corner portion lying at an axially lower edge of the projecting portion 731, i.e., a lower end of the projecting portion 731, and on the outer side in the first radial direction D1. The recessed portion 7311 is recessed upward and inward in the first radial direction D1 from the corner portion of the projecting portion 731 lying at the lower end of the projecting portion 731 and on the outer side in the first radial direction D1. The recessed portion 7311 is arranged to extend in the lateral direction (i.e., the circumferential direction), which is perpendicular to each of the first radial direction D1 and the axial direction. A corner portion of the recessed portion 7311 which lies on the upper side and on the inner side in the first radial direction D1 is defined by a right-angled depression in this modification as illustrated in FIG. 8, but may alternatively include an oblique surface or a curved surface.

The fourth gap 8318 is defined at a region where the recessed portion 7311 of the projecting portion 731 is opposed to a portion of an inner surface 8311 of an outer wall portion 8301 which lies below a window portion 832. The fourth gap 8318 is defined at a boundary between a support surface 8314 and the outer wall portion 8301.

This arrangement contributes to preventing the corner portion of the projecting portion 731 lying at the lower end of the projecting portion 731 and on the outer side in the first radial direction D1 from colliding against the portion of the inner surface 8311 which lies below the window portion 832 when the lens 70 is arranged in the accommodating portion 831. This in turn contributes to further improving the assembling workability for the rotary drive apparatus 1 when the lens 70 is arranged in the accommodating portion 831.

### 6-2. Rotary Drive Apparatus According to Second Modification

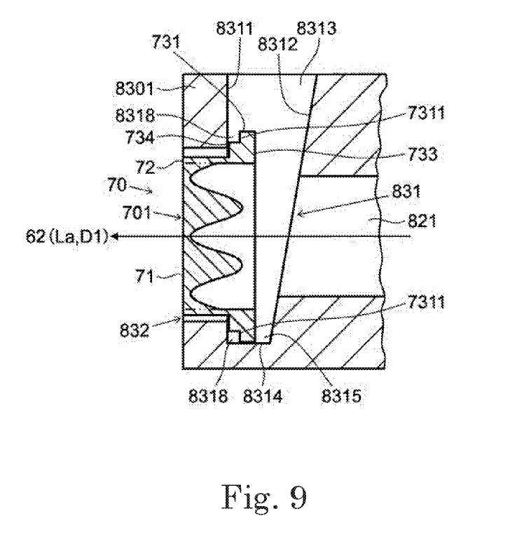

FIG. 9 is a vertical sectional view illustrating an accommodating portion 831, which is arranged to accommodate a lens 70, of a rotary drive apparatus 1 according to a second modification of the above-described preferred embodiment of the present invention.

Referring to FIG. 9, a projecting portion 731 of the lens 70 has a recessed portion 7311. In this modification, the recessed portion 7311 is arranged to extend over each of four sides of an outer peripheral edge of the projecting portion 731, the outer circumferential edge being rectangular when viewed in the first radial direction D1. In other words, the recessed portion 7311 is arranged to extend over the entire outer peripheral edge of the projecting portion 731.

The accommodating portion 831 has a fourth gap 8318. Because of the above recessed portion 7311, the fourth gap 8318 is arranged to extend over the entire outer peripheral edge of the projecting portion 731. This configuration allows an adhesive to smoothly flow along the fourth gap 8318. This contributes to improving assembling workability when the lens 70 is fixed in the accommodating portion 831. Further, a reduction in the amount of the adhesive used can be achieved.

### 6-3. Rotary Drive Apparatus According to Third Modification

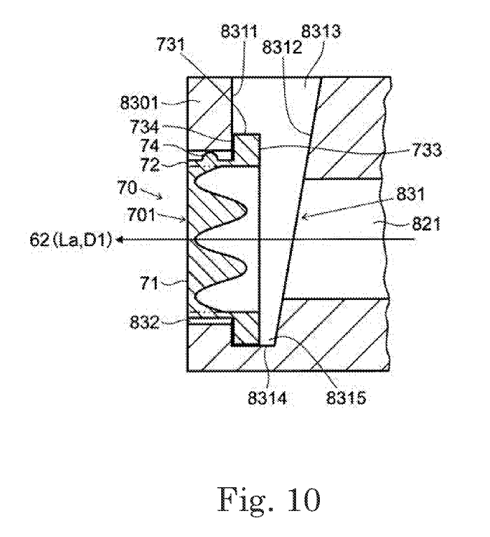

FIG. 10 is a vertical sectional view illustrating an accommodating portion 831, which is arranged to accommodate a lens 70, of a rotary drive apparatus 1 according to a third modification of the above-described preferred embodiment of the present invention. Referring to FIG. 10, the lens 70 has a projection portion 74.

The projection portion 74 is defined in an outer surface of a protective portion 72 of a base portion 701 inserted in a window portion 832. The projection portion 74 is defined, for example, on the upper side of the protective portion 72. The projection portion 74 is arranged to project upward toward a wall surface of the window portion 832. A top of the projection portion 74 makes contact with the wall surface of the window portion 832 from below.

With this configuration, a stress is applied from an outer wall portion 8301 onto the base portion 701 of the lens 70 with respect to a direction in which the projection portion 74 projects, and this leads to an improvement in the accuracy with which the lens 70 is positioned with respect to the accommodating portion 831.

Note that the projection portion may alternatively be defined in the wall surface of the window portion 832. In other words, the wall surface of the window portion 832 may include a projection portion arranged to project toward the base portion 701 of the lens 70.

### 6-4. Rotary Drive Apparatus According to Fourth Modification

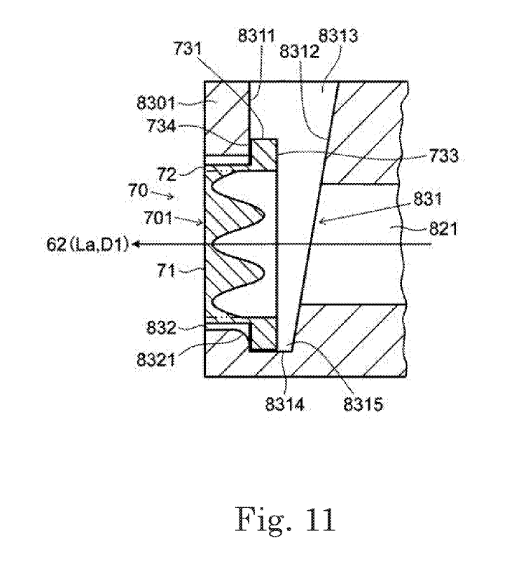

FIG. 11 is a vertical sectional view illustrating an accommodating portion 831, which is arranged to accommodate a lens 70, of a rotary drive apparatus 1 according to a fourth modification of the above-described preferred embodiment of the present invention. Referring to FIG. 11, a window portion 832 has a curved portion 8321.

The curved portion 8321 is arranged adjacent to a portion of an inner surface 8311 which lies below the window portion 832. The curved portion 8321 is defined between a lower end of the window portion 832 and a bottom portion of the accommodating portion 831. The curved portion 8321 is arranged to extend from the lower end of the window portion 832 toward a support surface 8314. The curved portion 8321 is curved to be convex upward.

This arrangement contributes to preventing a light-transmitting portion 71 of the lens 70 from colliding against a portion of an outer wall portion 8301 which lies below the window portion 832 when the lens 70 is inserted into the accommodating portion 831. The light-transmitting portion 71 of the lens 70 can thus be protected.

### 7. Others

While preferred embodiments of the present invention have been described above, it will be understood that the scope of the present invention is not limited to the above-described preferred embodiments, and that various modifications may be made to the above-described preferred embodiments without departing from the gist of the present invention. In addition, features of the above-described preferred embodiments and the modifications thereof may be combined appropriately as desired.

In the above-described preferred embodiment, the lens 70 is fixed in the accommodating portion 831 through the adhesive injected into the accommodating portion 831. Note, however, that the lens 70 may not necessarily be fixed in the accommodating portion 831 by this method. For example, the lens 70 may alternatively be fixed in the accommodating portion 831 through press fitting. Further, the lens 70 may alternatively be fixed in the accommodating portion 831 through welding or screwing.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus that rotates a flywheel holding a mirror that reflects incoming light coming from a light source, and a lens that allows reflected light obtained by reflection of the incoming light to pass therethrough, the rotary drive apparatus comprising:
a motor; and
the flywheel; wherein
the flywheel is supported by the motor and is rotatable about a central axis extending in a vertical direction;
the lens includes:
a base portion including a light-transmitting portion that allows the reflected light to pass therethrough; and
a projecting portion that projects in an axial direction relative to the base portion;
the flywheel includes an accommodating portion in which the lens is located;
the accommodating portion includes:
an insertion opening at an upper portion of the accommodating portion to allow the lens to be inserted therethrough;
a support surface below a light path of the reflected light to support the lens;
a slanting surface located radially inside of the lens and opposite to a radially inner surface of the lens, at a position at at least below the light path of the reflected light, and slanting radially outward with decreasing height;
an outer wall portion located radially outside and opposite to the slanting surface, and extending in the axial direction; and
a window portion located to pass through the outer wall portion in a radial direction, and to allow a portion of the base portion of the lens to be inserted therein;
the insertion opening extends from the slanting surface to an inner surface of the outer wall portion in the radial direction;
a shortest distance, measured along a normal to the slanting surface, between the slanting surface and a portion of the inner surface of the outer wall portion above the window portion is greater than a thickness of the base portion of the lens measured in the radial direction;
a dimension of the window portion measured in the vertical direction is greater than a dimension of a portion of the base portion inserted in the window portion measured in the vertical direction; and
the dimension of the window portion measured in the vertical direction is smaller than a dimension of the projecting portion of the lens measured in the vertical direction.

2. The rotary drive apparatus according to claim 1, wherein the accommodating portion includes a first gap between the slanting surface and the radially inner surface of the lens at a bottom portion of the accommodating portion.

3. The rotary drive apparatus according to claim 1, wherein the accommodating portion includes:
a second gap at a lower portion of the window portion, and being a vertical gap between a wall surface of the window portion and the portion of the base portion inserted in the window portion; and
a third gap at an upper portion of the window portion, and being a vertical gap between the wall surface of the window portion and the portion of the base portion inserted in the window portion; and
the third gap is larger than the second gap.

4. The rotary drive apparatus according to claim 1, wherein the accommodating portion includes a fourth gap at a boundary between the support surface and the outer wall portion at a region where an outer peripheral edge of the projecting portion of the lens is opposed to a portion of the inner surface of the outer wall portion below the window portion.

5. The rotary drive apparatus according to claim 4, wherein the fourth gap extends over the entire outer peripheral edge of the projecting portion of the lens.

6. The rotary drive apparatus according to claim 1, wherein at least one of a wall surface of the window portion and an outer surface of the portion of the base portion inserted in the window portion includes a projection portion projecting toward another one of the wall surface and the outer surface, and including a top able to make contact with the other one of the wall surface and the outer surface.

7. The rotary drive apparatus according to claim 1, wherein the window portion includes a curved portion that is curved convexly upward and is located between a lower end of the window portion and a bottom portion of the accommodating portion.
